(19) United States
(12) Patent Application Publication
(10) Pub. No.: US 2026/0259303 A1
(43) Pub. Date: Sep. 3, 2026

(54) IN-VEHICLE SYSTEM CONTROL DEVICE

(71) Applicant: TOYOTA JIDOSHA KABUSHIKI KAISHA, Toyota-shi (JP)

(72) Inventor: Yutaka YAMAGIWA, Seto-shi (JP)

(73) Assignee: TOYOTA JIDOSHA KABUSHIKI KAISHA, Toyota-shi (JP)

(21) Appl. No.: 19/414,472

(22) Filed: Dec. 10, 2025

(30) Foreign Application Priority Data
Feb. 28, 2025 (JP) 2025-032123

(51) Int. Cl. G01S 7/40; B60R 16/03; G01S 13/931; G07C 5/08

(52) U.S. Cl. CPC G01S 7/4039; B60R 16/03; G01S 13/931; G07C 5/0816

(57) ABSTRACT

The in-vehicle system control device is mounted on a vehicle having a plurality of in-vehicle systems that control a vehicle based on a detection result of a radar device mounted on the vehicle, and includes a controller that controls an operation of the plurality of in-vehicle systems based on a detection result of the radar device, and the controller temporarily stops the in-vehicle system in which the shielded orientation affects the control of the vehicle among the plurality of in-vehicle systems in response to the presence of the shielded orientation in which the radar of the radar device is shielded, and does not stop the in-vehicle system in which the shielded orientation does not affect the control of the vehicle among the plurality of in-vehicle systems.

### CROSS-REFERENCE TO RELATED APPLICATION

This application claims priority to Japanese Patent Application No. 2025-032123 filed on Feb. 28, 2025. The disclosure of the above-identified application, including the specification, drawings, and claims, is incorporated by reference herein in its entirety.

### BACKGROUND

### 1. Technical Field

The present disclosure relates to an in-vehicle system control device.

### 2. Description of Related Art

Japanese Unexamined Patent Application Publication No. 2020-121645 (JP 2020-121645 A) discloses, as a plurality of in-vehicle systems, pre-crash safety (PCS), lane tracing assist (LTA), road sign assist (RSA), radar cruise control (RCC), blind spot monitor (BSM), and rear cross traffic alert (RCTA).

### SUMMARY

The in-vehicle systems may control a vehicle based on the detection result from a radar device mounted on the vehicle. When mud, snow, or the like (hereinafter referred to as "dirt") adheres to the radar device or a bumper or the like on which the radar device is mounted, there is a possibility that a radar is attenuated by the dirt, and a target cannot be correctly recognized. Therefore, it is conceivable to stop all of the vehicle control systems when dirt adheres. However, there is an orientation in which the radar device can correctly perform detection, depending on the degree of adhesion of the dirt. The present disclosure provides a technique of suppressing all the in-vehicle systems that use a radar device being stopped due to dirt adhering to the radar device.

An aspect of the present disclosure provides an in-vehicle system control device including a controller mounted on a vehicle including a plurality of in-vehicle systems that controls the vehicle based on a detection result from a radar device mounted on the vehicle, the controller controlling operation of the in-vehicle systems based on the detection result from the radar device, in which in response to presence of a shielded orientation in which a radar from the radar device is shielded, the controller temporarily stops, among the in-vehicle systems, an in-vehicle system whose control of the vehicle is affected by the shielded orientation, and does not stop an in-vehicle system whose control of the vehicle is not affected by the shielded orientation.

According to the present disclosure, it is possible to suppress all the in-vehicle systems that use a radar device being stopped due to dirt adhering to the radar device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of a vehicle including an in-vehicle system control device according to an embodiment;

FIG. 2A is a plan view illustrating an example of a detection range of a side radar device in a front part of a vehicle and a range in which data required for an in-vehicle system is detected;

FIG. 2B is a plan view illustrating an example of a detection range of a side radar device in a rear portion of a vehicle and a range in which data required for an in-vehicle system is detected;

FIG. 3 is a plan view illustrating an example of a detection range of the radar device and a range in which data necessary for the in-vehicle system is detected in a case where dirt adheres to the radar device;

FIG. 4A is a plan view for explaining the determination of the shielding orientation of the radar device during running;

FIG. 4B is a plotting of reflected power and expectation for each bearing in the scene of FIG. 4A;

FIG. 5A is a plan view for explaining determination of a shielded orientation of a radar device while a vehicle is stopped or parked;

FIG. 5B is a plotting of reflected power and expectation for each bearing in the scene of FIG. 5A;

FIG. 6A is an example of a method of dividing a shielded orientation;

FIG. 6B is another illustration of the segmentation of shielding orientations;

FIG. 6C is yet another illustration of the screening orientation; and

FIG. 7A is a flowchart for monitoring a shielded orientation;

FIG. 7B is a flowchart for determining the presence or absence of an effect on the in-vehicle system.

### DETAILED DESCRIPTION OF EMBODIMENTS

Hereinafter, an embodiment of the present disclosure will be described with reference to the drawings.

### Configuration of Vehicle

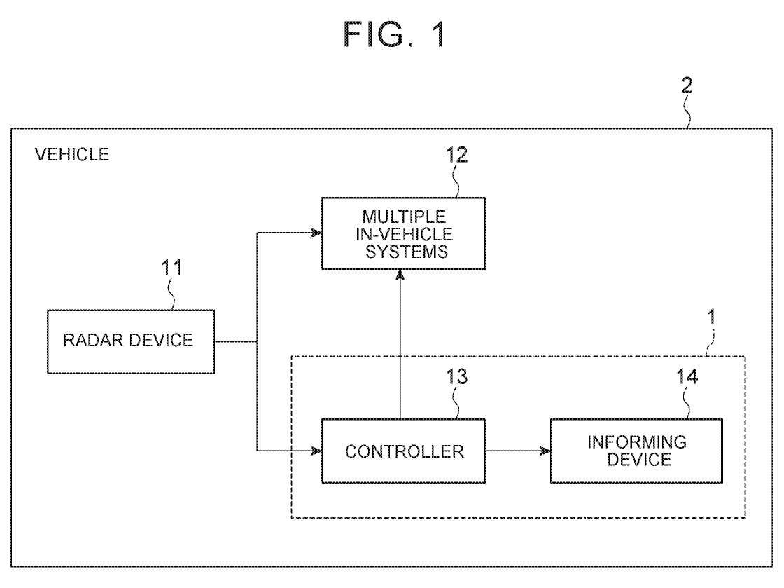

FIG. 1 is a block diagram illustrating an example of a configuration of a vehicle including an in-vehicle system control device according to an embodiment. As illustrated in FIG. 1, the in-vehicle system control device 1 is mounted on a vehicle 2. The vehicle 2 includes a radar device 11 that detects a target in the vicinity of the vehicle 2. The radar device 11 detects a target by emitting a radar to the periphery of the vehicle 2 and acquiring a reflected wave. The radar device 11 observes the positional relationship, the relative speed, and the radio wave reflection intensity with respect to the relatively moving object over time. The radar device 11 is, for example, a side radar device provided at front, rear, left, and right bumper end portions of the vehicle 2. The vehicle 2 may include only one radar device 11 or three or more radar devices.

The vehicle 2 includes a plurality of in-vehicle systems 12. The plurality of in-vehicle systems 12 control the vehicle 2 based on the detection result of the radar device 11. The plurality of in-vehicle systems 12 operate the actuators of the vehicle 2 to control the traveling state or operate the speakers of the vehicle 2 to notify the occupant of information, based on the detection results of the radar device 11. The plurality of in-vehicle systems 12 is not particularly limited as long as they use the detection result of the radar device 11.

The plurality of in-vehicle systems 12 may include, for example, pre-crash safety (PCS), front cross traffic alerts (FCTA), lane change assist (LCA), blind spot monitor (BSM), rear cross traffic alerts (RCTA), flash hazard lights (FHL), etc. PCS detects a different vehicle approaching the vehicle 2 and supports collision avoidance or reduces collision damage. FCTA detects different vehicles approaching from the left and right in front of the vehicle 2 and alerts the driver. LCA detects different vehicles in the vicinity of the vehicle 2 and supports a part of the steering wheel manipulation required for lane change. BSM detects a different vehicle located behind the vehicle 2 and assists the driver in determining when the lane is changed. RCTA detects a different vehicle located at the rear of the vehicle 2 and assists in confirming the rear area that is difficult to be detected only by the driver's visual inspection. FHL detects a different vehicle approaching the vehicle 2 from the rear of the vehicle and causes the hazard lamp to blink.

Since the support content of each of the plurality of in-vehicle systems 12 is different, a range in which data required for the in-vehicle system is detected is different. In the following description, a range viewed from the viewpoint of the radar device is also referred to as an orientation.

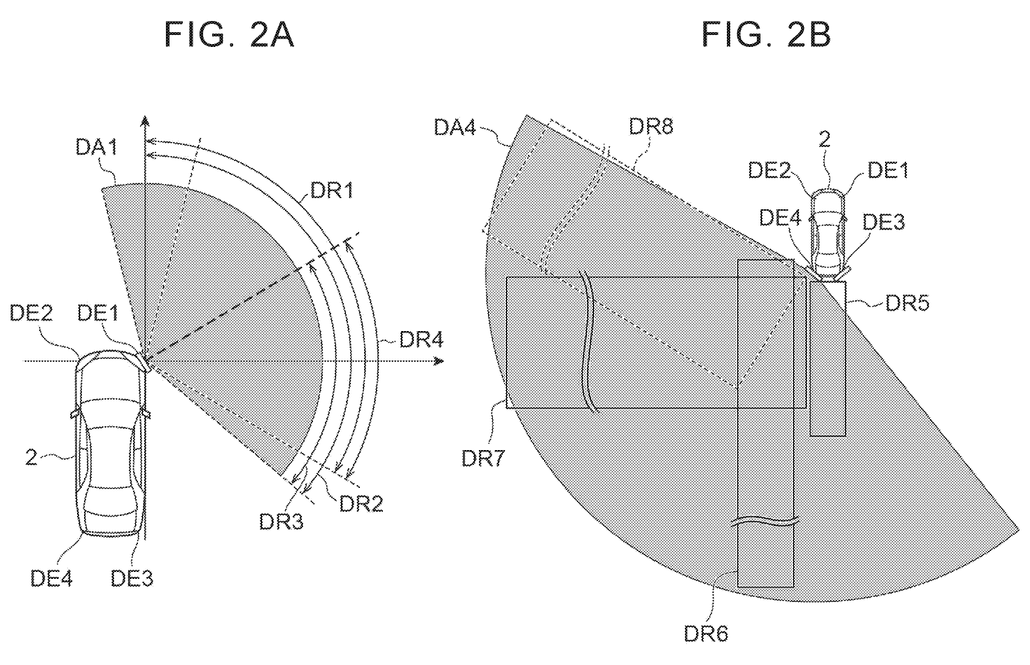

FIG. 2A is a plan view illustrating an example of a detection range of a side radar device in a front part of a vehicle and a range in which data required for an in-vehicle system is detected. As shown in FIG. 2A, the vehicles 2 are provided with four side radar devices from DE1 to DE4 as the radar devices 11. The detection range DA1 of the right front side radar device DE1 of the vehicle 2 is a range indicated by gray. Among the data detected in the detection range DA1, an orientation in which data required for the first PCS is detected is an orientation indicated by an arrow DR1. Similarly, the orientation in which LCA needs to be detected is the orientation indicated by the arrow DR2. The orientation in which the second PCS needs to be detected is the orientation indicated by the arrow DR3. The direction in which FCTA is required is indicated by an arrow DR4.

FIG. 2B is a plan view illustrating an example of a detection range of a side radar device in a rear portion of a vehicle and a range in which data required for an in-vehicle system is detected. As shown in FIG. 2B, the detection range DA4 of the right rear side radar device DE4 of the vehicle 2 is a range indicated by gray. Among the data detected in the detection range DA4, a range in which data required for FHL is detected is a range DR5. Similarly, the range in which BSM needs to be detected is the range DR6. The range DR6 may be divided into two ranges: a range close to the vehicle and a range far from the vehicle. The range in which the data required for RCTA is detected is the range DR7. The range in which the data required for RCTA is detected is a range DR8 when oblique parking is executed.

Returning to FIG. 1, the in-vehicle system control device 1 includes a controller 13 that controls operations of a plurality of in-vehicle systems based on a detection result of the radar device 11. The controllers 13 are configured as, for example, ECU (Electronic Control Unit). ECU is an electronic control unit having a processor such as CPU (Central Processing Unit), a storage device such as ROM (Read Only Memory) and RAM (Random Access Memory), a storage device such as CAN (Controller Area Network) communication circuit, and an input/output circuit. The controllers 13 may be configured by a plurality of ECU.

The controller 13 is connected to the radar device 11. The controller 13 acquires relative position information of the target from the radar device 11. The controller 13 acquires dynamic/static information of the vehicle 2 from an internal sensor (not shown). The dynamic/static information includes vehicle speed, turning information (steering angle, yaw rate, and the like), information related to brakes, information related to parking brakes, and the like.

The controller 13 is connected to a plurality of in-vehicle systems 12. The controller 13 individually controls the operations of the plurality of in-vehicle systems 12. The controller 13 temporarily stops or resumes the operation for each in-vehicle system. For example, the controller 13 controls the operations of the plurality of in-vehicle systems 12 by outputting a stop signal, a resume signal, and the like to each of the plurality of in-vehicle systems 12. Note that the temporary stop of the system includes not only the stop of the function exhibited by the system but also the degeneracy of the function.

The in-vehicle system control device 1 includes an informing device 14. The controller 13 is connected to the informing device 14. The controller 13 causes the informing device 14 to notify the temporary stop in response to the temporary stop of the in-vehicle system. Note that the informing device 14 may not be provided.

### Controller Details

The controller 13 uses the detection result of the radar device 11 to determine the temporary stop and resumption of the in-vehicle system. When dirt adheres to the radar device 11 or a bumper or the like on which the radar device 11 is mounted, there is a possibility that the radar is attenuated by the dirt, and the target cannot be correctly recognized.

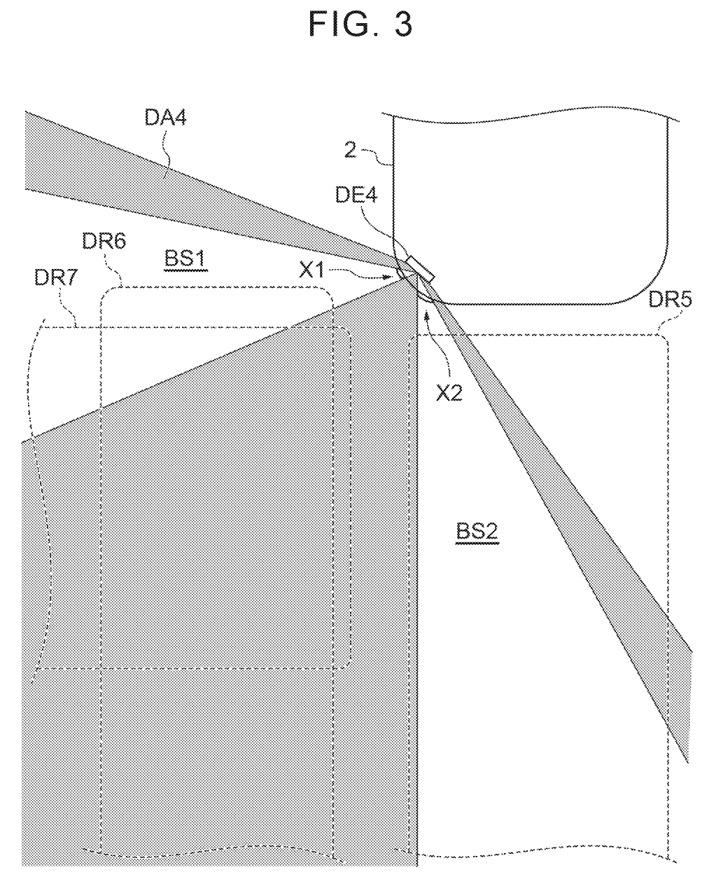

FIG. 3 is a plan view illustrating an example of a detection range of the radar device and a range in which data necessary for the in-vehicle system is detected in a case where dirt adheres to the radar device. As shown in FIG. 3, it is assumed that the first dirt X1 and the second dirt X2 adhere to the side radar device DE4 of the right rear portion of the vehicle 2. Here, the detection range DA4 of the side radar device DE4 is a range indicated by gray. In other words, in the direction in which the first dirt X1 is attached (an exemplary shielded orientation), there is a first blind spot range BS1 in which the radar is attenuated, and the target cannot be correctly recognized. Similarly, in an orientation in which the second dirt X2 is attached (an exemplary shielding orientation), there is a second blind spot range BS2 in which the radar is attenuated, and the target cannot be correctly recognized.

The controller 13 temporarily stops the in-vehicle system in which the shielded orientation affects the control of the vehicle 2 among the plurality of in-vehicle systems 12 in response to the presence of the shielded orientation in which the radar of the radar device 11 is shielded. At this time, the controller 13 does not stop the in-vehicle system in which the shielded orientation does not affect the control of the vehicle 2 among the plurality of in-vehicle systems 12.

Whether or not the shielded orientation affects the control of the vehicle 2 is determined by the degree of overlap between the range in which data necessary for each in-vehicle system is detected and the blind spot range. For example, the first blind spot range BS1 overlaps the range DR6 in which the data required for BSM is detected and the range DR7 in which the data required for RCTA is detected and does not overlap the range DR5 in which the data required for FHL is detected. In FIG. 3, when only the first blind spot range BS1 is present, the controller 13 temporarily stops BSM and RCTA in response to the presence of the first blind spot range BS1 and causes FHL to continue.

For example, the second blind spot range BS2 overlaps the range DR5 in which data required for FHL is detected and does not overlap the range DR6 in which data required for BSM is detected, and the range DR7 in which data required for RCTA is detected. In FIG. 3, when only the second blind spot range BS2 is present, the controller 13 temporarily stops FHL and causes BSM and RCTA to continue in response to the presence of the second blind spot range BS2.

The threshold value of the degree of overlap used for determining whether or not the shielded orientation affects the control of the vehicle 2 may be appropriately set. For example, the controller 13 may determine that there is an influence when the blind spot range occupies 1% or more of the range in which data required for the in-vehicle system is detected or may determine that there is an influence when the blind spot range occupies 10% or more. In addition, although the above-described determination uses a range (plane), the determination may be performed by using an overlap between an orientation in which data necessary for the in-vehicle system is detected and a shielded orientation.

The controller 13 may monitor whether or not a shielded orientation exists in the detected orientation of the radar device 11 and may resume the operation of the in-vehicle system that has been temporarily stopped in response to the absence of the existing shielded orientation.

### Details of the determination of the shielded orientation

In the determination of the shielded orientation, there are two patterns: a pattern performed while the vehicle 2 is traveling and a pattern performed while the vehicle is stopping or parking.

### Determination of Shielded Orientation during Running

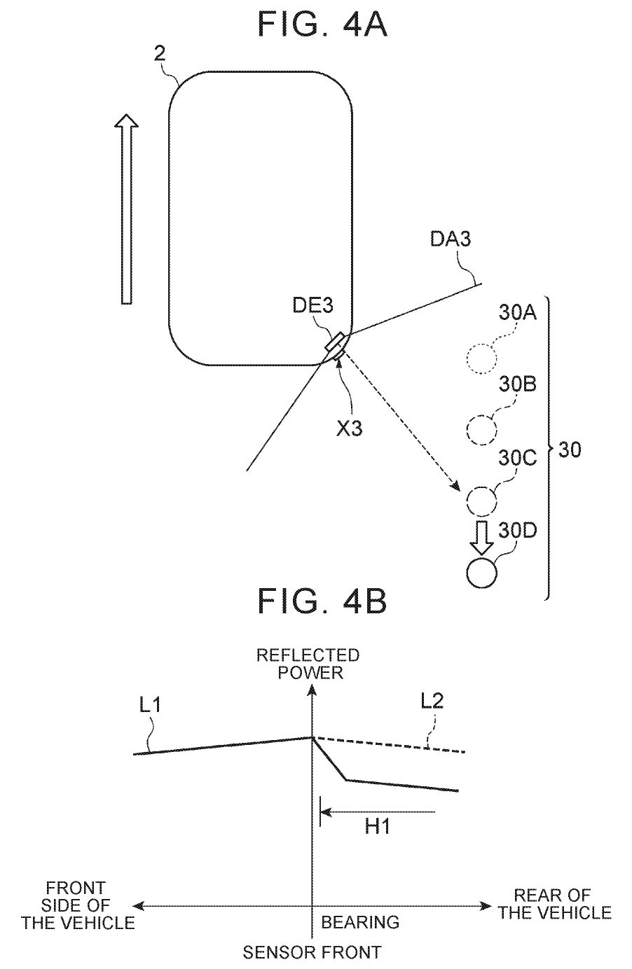

FIG. 4A is a plan view for explaining the dirt determination of the radar device during traveling, and FIG. 4B is a graph plotting reflected power and expected power for each orientation in the scene of FIG. 4A. As shown in FIG. 4A, it is assumed that a stationary object 30 exists around the vehicles 2. The side radar device DE3 of the vehicles 2 detects the stationary object 30. When the vehicle 2 travels, the relative position between the vehicle 2 and the stationary object 30 is changed. In FIG. 4A, it is assumed that the vehicles 2 are traveling in the directions indicated by arrows. Here, the stationary object 30 viewed from the vehicle 2 moves as in the position 30A, 30B, 30C and 30D.

The controller 13 detects the stationary object 30 during traveling and acquires the reflected power of the radar from the stationary object 30. For example, the reflected power in the position 30A, the reflected power in the position 30B, the reflected power in the position 30C, and the reflected power in the position 30D are acquired in time series.

As shown in FIG. 4A, it is assumed that the side radar device DE3 has a third dirt X3 attached thereto, and a stationary object 30 is present in front of the side radar device DE3, that is, in the position 30C. The reflected power obtained with the orientation indicated by the dashed arrows in FIG. 4A as the sensor front is shown in FIG. 4B. As shown in FIG. 4B, the reflected power is a graphical L1 indicated by a solid line. The controller 13 calculates an expected value of the reflected power of the stationary object 30 in the position 30C based on the reflected power of the position 30A or the position 30B. The controller 13 may calculate the expected value based on the reflected power of the position 30A or the position 30B, the relative position information of the stationary object 30, and the dynamic/static information of the vehicle 2. For example, the controller 13 may calculate an expected value based on the traveling direction and speed of the vehicle 2 and the detected position of the stationary object 30. The expected value is a graph L2 indicated by a broken line. When the acquired reflected power falls below the expected value by a predetermined value or more, the controller 13 determines that the shielded orientation H1 exists. The predetermined value may be appropriately set. In this way, it is determined that the area where the reflected power decreases from the expected value is the shielded orientation H1.

### Determination of Shield Orientation during Stop or Parking

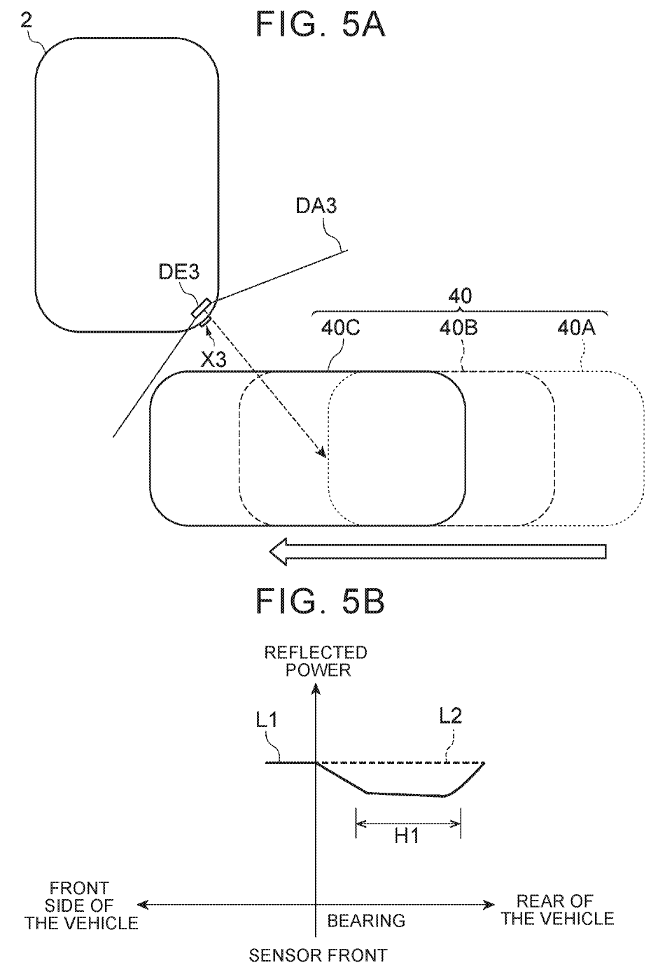

FIG. 5A is a plan view for explaining the dirty determination of the radar device while parking or stopping, and FIG. 5B is a graph plotting the reflected power and expected value per orientation in the scene of FIG. 5A. As shown in FIG. 5A, it is assumed that the different vehicle 40, which is a moving object, travels around the vehicle 2. The side radar device DE3 of the vehicle 2 detects the different vehicle 40. When the different vehicle 40 travels, the relative position between the vehicle 2 and the different vehicle 40 is changed. In FIG. 5A, it is assumed that the different vehicles 40 are traveling in the directions indicated by arrows. In this case, the different vehicle 40 viewed from the vehicle 2 moves like the position 40A, 40B and 40C.

The controller 13 detects the different vehicle 40 while the vehicle is stopped or parked and acquires the reflected power of the radar from the different vehicle 40. For example, the reflected power in the position 40A, the reflected power in the position 40B, and the reflected power in the position 40C are acquired in time series.

As shown in FIG. 5A, it is assumed that the side radar device DE3 has a third dirt X3 attached thereto, and the different vehicles 40 exist in front of the side radar device DE3, that is, in the position 40B. The reflected power obtained with the orientation indicated by the dashed arrows in FIG. 5A as the sensor front is shown in FIG. 5B. As shown in FIG. 5B, the reflected power is a graphical L1 indicated by a solid line. The controllers 13 calculate the expected values of the reflected power of the different vehicles 40 in the position 40B based on the reflected power of the position 40A. The controller 13 may calculate the expected value based on the reflected power of the position 40A, the relative position information of the different vehicle 40, and the dynamic/static information of the vehicle 2. For example, the controller 13 may calculate an expected value based on the traveling direction and speed of the different vehicle 40 and the detected position of the different vehicle 40. The expected value is a graph L2 indicated by a broken line. When the acquired reflected power falls below the expected value by a predetermined value or more, the controller 13 determines that the shielded orientation H1 exists. The predetermined value may be appropriately set. In this way, it is determined that the area where the reflected power decreases from the expected value is the shielded orientation H1.

### Details on How to Separate the Shielded Orientation

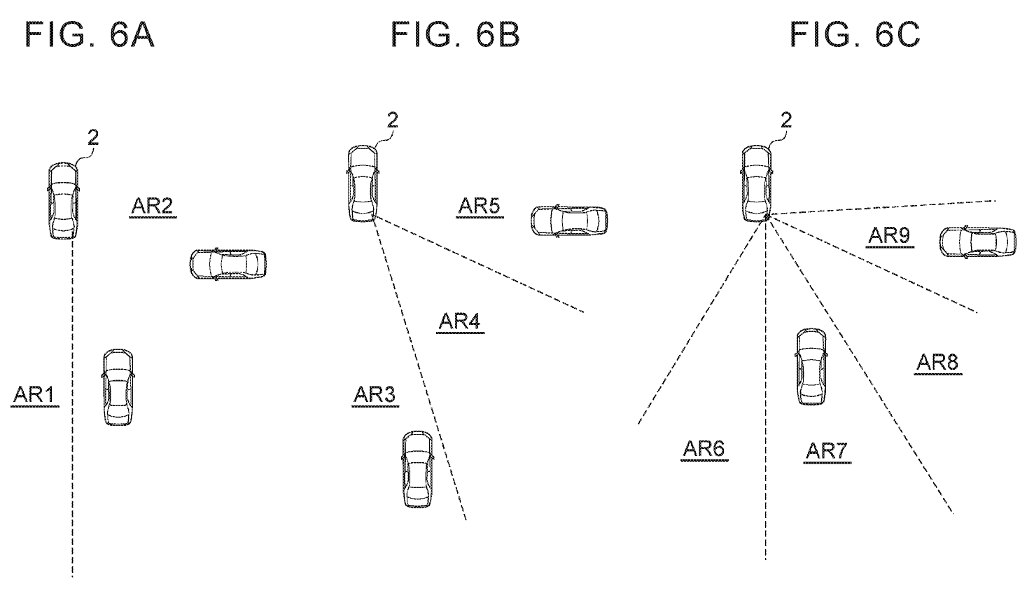

The orientation around the vehicle 2 can be classified as appropriate. FIG. 6A is an example of the dividing direction of the shielding orientation. As shown in FIG. 6A, the side radar device DE3 is classified as a rear area AR1 and a side area AR2. For example, the entire orientation of the area including the shielded orientation is defined as the shielded orientation. For example, when the shielded orientation is included in the rear area AR1, the entire rear area AR1 is defined as the shielded orientation. FIG. 6B is another exemplary method of dividing the shielded orientation. As shown in FIG. 6B, the side radar device DE3 is classified as a far area AR3, a near area AR4, and a side area AR5. FIG. 6C is still another example of a division direction of the shielded orientation. As shown in FIG. 6C, the side radar device DE3 may be classified into a first area AR6, a second area AR7, a third area AR8, and a fourth area AR9 according to an orientation angle.

### Degree of Shielding

The controller 13 may determine each orientation by a single-bit representation indicating either attenuation or non-attenuation or may determine each orientation by expressing the degree of attenuation with respect to an expected value of the reflected power by two or more bits. In this case, the controller 13 can calculate the degree of attenuation as the degree of shielding. The controller 13 may cause the informing device 14 to notify the degree of shielding or may determine whether to cause the informing device 14 to notify the degree of shielding. The controller 13 may adopt the degree of shielding in the determination of shielding.

### Operation of In-Vehicle System Control Device

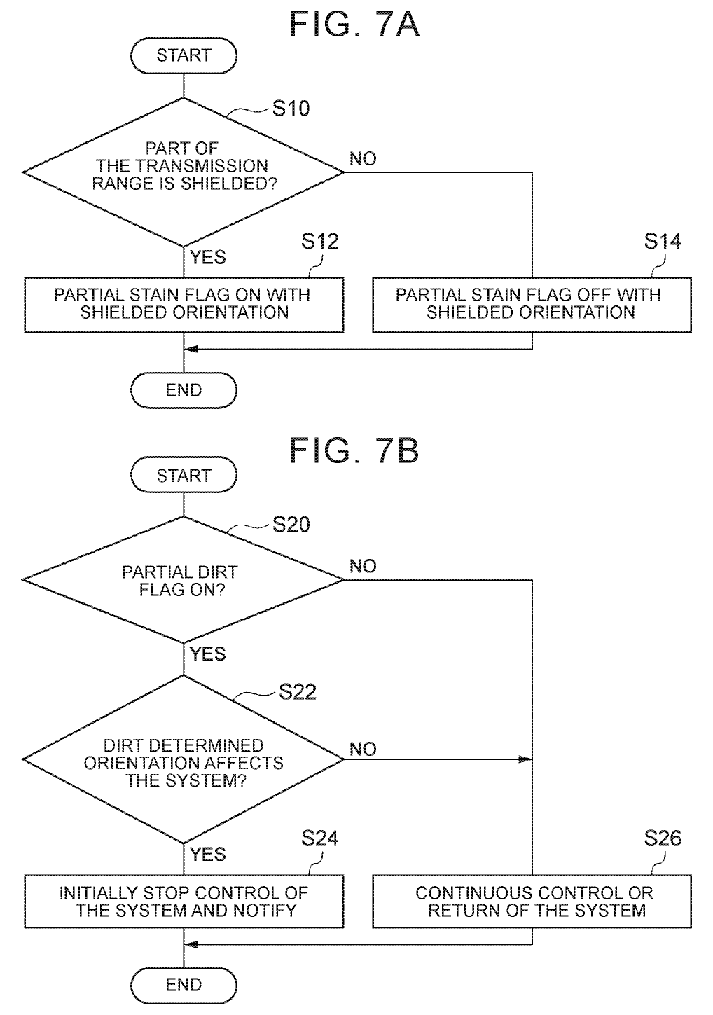

FIG. 7A is a flowchart for monitoring a shielded orientation. The flowchart shown in FIG. 7A is executed, for example, at a timing when the controller 13 receives the ignition ON.

As shown in FIG. 7A, the controllers 13 determine whether or not there is a shield in a part of the transmission range (detection range) of the radar device 11 in S10. The controller 13 determines the presence or absence of the shielding by the method described in detail in the determination of the shielded orientation.

When it is determined that there is shielding in a part of the transmission range of the radar device 11 (S10: YES), the controllers 13 ON the partially dirty flags of the shielded orientation in S12. The partial dirt flag is a flag for storing the presence or absence of shielding and is prepared for each orientation or for each classified orientation range.

When it is determined that there is no shielding in a part of the transmission range of the radar device 11 (S10: NO), the controllers 13 turns OFF the partially dirty flags in the shielded orientation in S14.

Upon completion of S12 and S14, the flowchart shown in FIG. 7A ends. The controller 13 executes the flowchart shown in FIG. 7A from the beginning until the termination condition is satisfied. The end-condition is, for example, when an ignition OFF or an instruction to end monitoring is received from the driver.

FIG. 7B is a flowchart for determining the presence or absence of an effect on the in-vehicle system. The flowchart shown in FIG. 7B is executed for each in-vehicle system, and is executed, for example, at a timing when the controller 13 receives the in-vehicle system ON.

As shown in FIG. 7B, the controllers 13 determine whether the partial dirt flag is ON in S20.

When it is determined that the partial dirt flag is ON (S20: YES), the controller 13 determines, in S22, whether or not the direction in which the dirt determination is made affects the in-vehicle system. For example, the controller 13 determines whether or not the dirt-determined orientation affects the in-vehicle system on the basis of an overlap between the dirt-determined orientation and an orientation in which data necessary for the in-vehicle system is detected.

When it is determined that the dirty direction affects the in-vehicle system (S22: YES), the controller 13 causes the control of the in-vehicle system to be temporarily stopped in S24 and causes the informing device 14 to notify that the control is temporarily stopped.

When it is determined that the partial dirt flag is OFF (S20: NO), the controller 13 continues the control of the in-vehicle system in S26. When the control of the in-vehicle system is temporarily stopped, the controller 13 returns the control of the in-vehicle system.

Upon completion of S24 and S26, the flowchart shown in FIG. 7B ends. The controller 13 executes the flowchart shown in FIG. 7B from the beginning until the termination condition is satisfied. For example, when an instruction to OFF the in-vehicle system or to terminate the monitoring is received from the driver.

### Summary of Embodiments

According to the in-vehicle system control device 1, in response to the presence of the shielded orientation H1 in which the radar of the radar device 11 is shielded, the in-vehicle system in which the shielded orientation H1 affects the control of the vehicle 2 among the plurality of in-vehicle systems 12 is temporarily stopped. At this time, the in-vehicle system in which the shielded orientation H1 does not affect the control of the vehicle 2 among the plurality of in-vehicle systems 12 is not stopped. As a result, the in-vehicle system control device 1 can suppress all in-vehicle systems using the radar device 11 being stopped due to dirt adhering to the radar device 11. Therefore, the availability of the in-vehicle system is improved.

While exemplary embodiments have been described above, various omissions, substitutions, combinations, and changes may be made without being limited to the exemplary embodiments described above.

What is claimed is:

1. An in-vehicle system control device comprising
a controller mounted on a vehicle including a plurality of in-vehicle systems that controls the vehicle based on a detection result from a radar device mounted on the vehicle, the controller controlling operation of the in-vehicle systems based on the detection result from the radar device, wherein
in response to presence of a shielded orientation in which a radar from the radar device is shielded, the controller temporarily stops, among the in-vehicle systems, an in-vehicle system whose control of the vehicle is affected by the shielded orientation and does not stop an in-vehicle system whose control of the vehicle is not affected by the shielded orientation.

2. The in-vehicle system control device according to claim 1, further comprising
an informing device that informs a driver of information, wherein
the controller causes the informing device to indicate a temporary stop in response to temporarily stopping the in-vehicle system whose control of the vehicle is affected by the shielded orientation.

3. The in-vehicle system control device according to claim 1, wherein the controller monitors whether the shielded orientation in which the radar from the radar device is shielded is present, and resumes the operation of the in-vehicle system that has been temporarily stopped in response to the shielded orientation that has been present being no longer present.

4. The in-vehicle system control device according to claim 1, wherein the controller detects a stationary object that is present around the vehicle during travel, acquires electric power of the radar reflected from the stationary object, calculates an expected value of the reflected electric power based on an advancing direction and a speed of the vehicle and a detected position of the stationary object, and determines that the shielded orientation is present when the acquired reflected electric power is less than the expected value by a predetermined value or more.

5. The in-vehicle system control device according to claim 1, wherein the controller detects a different vehicle traveling around the vehicle while the vehicle is stopped or parked, acquires electric power of the radar reflected from the different vehicle, calculates an expected value of the reflected electric power based on an advancing direction, a speed, and a detected position of the different vehicle, and determines that the shielded orientation is present when the acquired reflected electric power is less than the expected value by a predetermined value or more.
